(19) United States
(12) Patent Application Publication
(10) Pub. No.: US 2022/0177007 A1
(43) Pub. Date: Jun. 9, 2022

(54) VEHICLE CONTROL SYSTEM

(71) Applicant: TOYOTA JIDOSHA KABUSHIKI KAISHA, Toyota-shi Aichi-ken (JP)

(72) Inventors: Kazuki Nemoto, Susono-shi Shizuoka-ken (JP); Shin Tanaka, Numazu-shi Shizuoka-ken (JP); Satoshi Nakamura, Susono-shi Shizuoka-ken (JP)

(73) Assignee: TOYOTA JIDOSHA KABUSHIKI KAISHA, Toyota-shi Aichi-ken (JP)

(21) Appl. No.: 17/485,944

(22) Filed: Sep. 27, 2021

(30) Foreign Application Priority Data
Dec. 4, 2020 (JP) 2020-202173

(51) Int. Cl. B60W 60/00; B60W 50/029; B60W 50/02; B60W 50/08

(52) U.S. Cl. CPC B60W 60/00186; B60W 50/029; B60W 50/0205; B60W 2420/30; B60W 2050/021; B60W 2050/0215; B60W 50/082

(57) ABSTRACT

A vehicle control system controls a vehicle including a stop switch. A recognition sensor is configured to recognize a situation around the vehicle. The vehicle control system executes vehicle traveling control for generating a target trajectory of the vehicle based on a recognition result by the recognition sensor and executing control such that the vehicle follows the target trajectory. The vehicle control system executes the evacuation control that is the vehicle traveling control for evacuating the vehicle to the target position in a case where the vehicle traveling control is normal when the stop switch is pressed. The vehicle control system executes deceleration-and-stop control for decelerating the vehicle to stop the vehicle without using the target trajectory in a case where the vehicle traveling control is abnormal when the stop switch is pressed.

### CROSS-REFERENCE TO RELATED APPLICATION

This application claims priority to Japanese Patent Application No. 2020-202173 filed on Dec. 4, 2020, incorporated herein by reference in its entirety.

### BACKGROUND

### 1. Technical Field

The present disclosure relates to a vehicle control system that controls a vehicle including a stop switch.

### 2. Description of Related Art

Japanese Unexamined Patent Application Publication No. 2017-114195 discloses a vehicle control device. The vehicle control device executes first control (collision avoidance control) for avoiding collision of a vehicle with an obstacle. Furthermore, the vehicle control device executes second control, such as cruise control or lane keeping control. The vehicle control device recognizes an obstacle around the vehicle and determines whether or not a predetermined collision avoidance condition is established based on a recognition result. When determination is made that the collision avoidance condition is established during the execution of the second control, the vehicle control device stops the second control and executes the first control. That is, the degree of priority of the first control is higher than the degree of priority of the second control.

### SUMMARY

A vehicle including a stop switch for instructing an emergency stop is considered. When the stop switch is pressed, it is desirable to stop the vehicle with safety depending on situations.

An aspect of the disclosure relates to a vehicle control system that controls a vehicle including a stop switch. The vehicle control system includes one or more processors, and a recognition sensor configured to recognize a situation around the vehicle. The one or more processors are configured to execute vehicle traveling control for generating a target trajectory of the vehicle based on a recognition result by the recognition sensor and executing control such that the vehicle follows the target trajectory. The one or more processors are configured to execute evacuation control that is the vehicle traveling control for evacuating the vehicle to a target position in a case where the vehicle traveling control is normal when the stop switch is pressed. The one or more processors are configured to execute deceleration-and-stop control for decelerating the vehicle to stop the vehicle without using the target trajectory in a case where the vehicle traveling control is abnormal when the stop switch is pressed.

According to the aspect of the disclosure, the vehicle control system executes the vehicle traveling control for generating the target trajectory based on the recognition result by the recognition sensor and executing control such that the vehicle follows the target trajectory. The vehicle control system executes the evacuation control that is the vehicle traveling control for evacuating the vehicle to the target position in a case where the vehicle traveling control is normal when the stop switch is pressed. Since the evacuation control is executed in association with the target trajectory generated based on the recognition result by the recognition sensor, it is possible to stop the vehicle with safe and with high accuracy.

On the other hand, the vehicle control system executes the deceleration-and-stop control for decelerating the vehicle to stop the vehicle without using the target trajectory in a case where the vehicle traveling control is abnormal when the stop switch is pressed. Even with the deceleration-and-stop control, since at least the vehicle is stopped, a minimum extent of safety is secured. Furthermore, since the vehicle traveling control where an abnormality occurs is not used, the occurrence of an unexpected accident is restrained.

In this way, according to the aspect of the disclosure, it is possible to stop the vehicle with safety depending on situations when the stop switch mounted in the vehicle is pressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating the outline of a vehicle control system and vehicle traveling control according to an embodiment of the disclosure;

FIG. 2 is a conceptual diagram illustrating an example of an evacuation control according to the embodiment of the disclosure;

FIG. 3 is a conceptual diagram illustrating another example of evacuation control according to the embodiment of the disclosure;

FIG. 4 is a conceptual diagram illustrating deceleration-and-stop control according to the embodiment of the disclosure;

FIG. 5 is a block diagram showing a configuration example of the vehicle control system according to the embodiment of the disclosure;

FIG. 6 is a block diagram showing an example of driving environment information according to the embodiment of the disclosure;

FIG. 7 is a block diagram showing a functional configuration example related to the vehicle traveling control including autonomous driving control and traveling assistance control according to the embodiment of the disclosure;

FIG. 8 is a conceptual diagram illustrating an example of the traveling assistance control according to the embodiment of the disclosure;

FIG. 9 is a block diagram illustrating emergency stop processing according to the embodiment of the disclosure;

FIG. 10 is a flowchart showing emergency stop processing according to the embodiment of the disclosure;

FIG. 11 is a flowchart showing a first example of the emergency stop processing according to the embodiment of the disclosure;

FIG. 12 is a flowchart showing a second example of the emergency stop processing according to the embodiment of the disclosure;

FIG. 13 is a flowchart showing a third example of the emergency stop processing according to the embodiment of the disclosure; and

FIG. 14 is a flowchart showing a fourth example of the emergency stop processing according to the embodiment of the disclosure.

### DETAILED DESCRIPTION OF EMBODIMENTS

An embodiment of the disclosure will be described referring to the accompanying drawings.

### 1. Outline

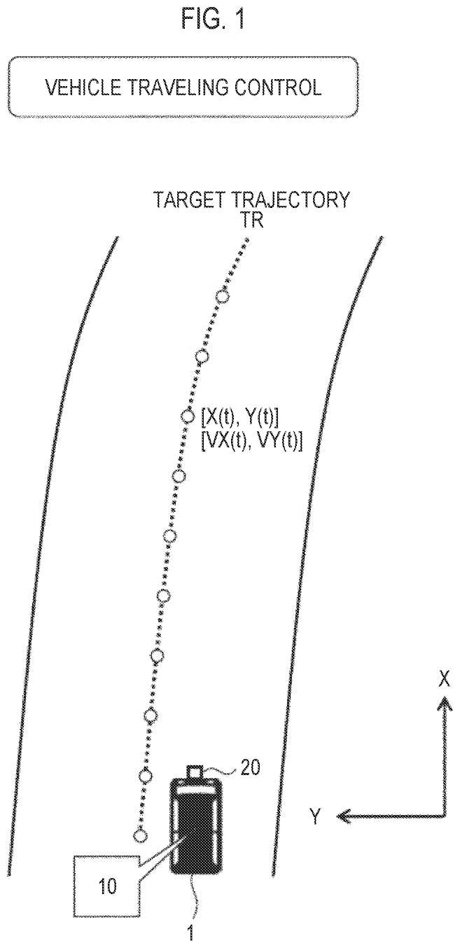

FIG. 1 is a conceptual diagram illustrating the outline of a vehicle control system 10 according to the embodiment. The vehicle control system 10 controls the vehicle 1. Typically, the vehicle control system 10 is mounted in the vehicle 1. Alternatively, at least a part of the vehicle control system 10 may be disposed in an external apparatus outside the vehicle 1 and may control the vehicle 1 remotely. That is, the vehicle control system 10 may be disposed in the vehicle 1 and the external apparatus in a dispersed manner.

In particular, the vehicle control system 10 executes “vehicle traveling control” for controlling traveling of the vehicle 1. Examples of the vehicle traveling control include autonomous driving control and traveling assistance control.

The autonomous driving control controls autonomous driving of the vehicle 1. As the autonomous driving herein, it is assumed that a driver may not always concentrate on driving 100% (for example, autonomous driving of so-called level 3 or higher).

The traveling assistance control controls at least one of steering, acceleration, and deceleration of the vehicle 1 for improvement of safety of traveling of the vehicle 1. Examples of such traveling assistance control include risk avoidance control and lane departure suppression control. The risk avoidance control executes at least one of steering control and deceleration control to reduce a collision risk of the vehicle 1 with an object. The lane departure suppression control suppress departure of the vehicle 1 from a traveling lane. The traveling assistance control does not constantly operate, and operates in response to establishment of a predetermined operation condition.

For such vehicle traveling control, a recognition sensor (external sensor) 20 mounted in the vehicle 1 is used. The recognition sensor 20 is a sensor that recognizes a situation around the vehicle 1. Examples of the recognition sensor 20 include laser imaging detection and ranging (LIDAR), a camera, and a radar. With the use of the recognition sensor 20, road configurations (white lines and the like) and objects (pedestrians, bicycles, two-wheeled vehicles, other vehicles, and the like) around the vehicle 1 can be recognized. Then, the vehicle control system 10 executes the vehicle traveling control based on a recognition result by the recognition sensor 20.

In more detail, the vehicle control system 10 generates a target trajectory TR of the vehicle 1 based on the recognition result by the recognition sensor 20. The target trajectory TR includes a target position [X(t),Y(t)] and a target speed [VX(t),VY(t)] of the vehicle 1 within a road on which the vehicle 1 travels. In an example shown in FIG. 1, the X direction is a forward direction of the vehicle 1, and the Y direction is a direction of plane perpendicular to the X direction. Note that a coordinate system (X,Y) is not limited to the example shown in FIG. 1. The target position [X(t),Y(t)] and the target speed [VX(t),VY(t)] are a function of time t. The target speed [VX(t),VY(t)] may be set for each target position [X(t),Y(t)]. That is, the target position [X(t),Y(t)] and the target speed [VX(t),VY(t)] may be associated with each other. The vehicle control system 10 executes the vehicle traveling control such that the vehicle 1 follows the target trajectory TR.

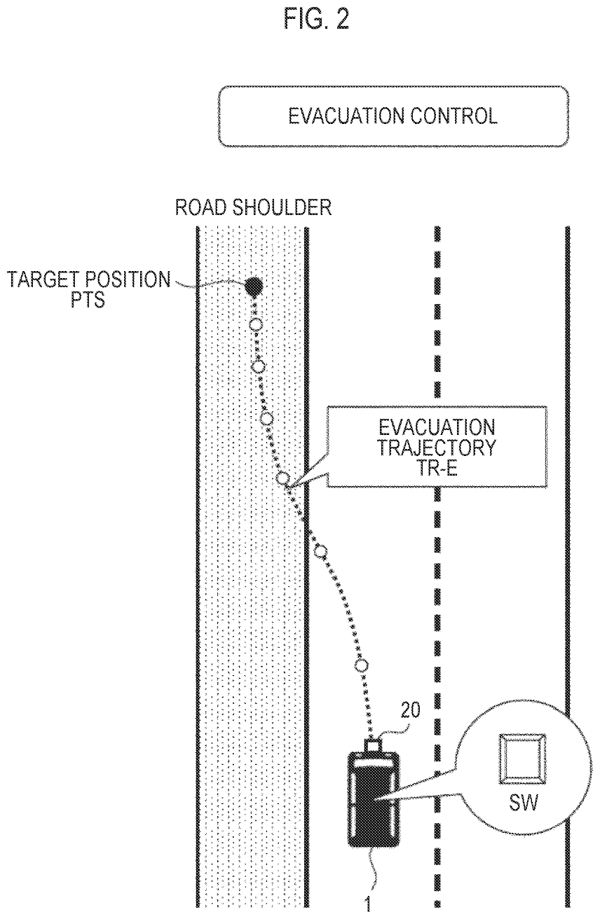

Next, processing related to a “stop switch SW” will be described referring to FIGS. 2 to 4. The stop switch SW is a switch that is pressed by a person to instruct an emergency stop. The stop switch SW is mounted in the vehicle 1. For example, the stop switch SW is provided in a driver's seat. As another example, when the vehicle 1 is a bus or the like, the stop switch SW may be provided in a passenger space.

When the stop switch SW is pressed, the vehicle control system 10 executes “emergency stop processing” for emergency stopping the vehicle 1. For example, the vehicle control system 10 evacuates the vehicle 1 to a safe position using vehicle traveling control based on the recognition result by the above-described recognition sensor 20. The vehicle traveling control for evacuating the vehicle 1 to the safe position is hereinafter referred to as “evacuation control”. The evacuation control includes at least deceleration control, and may further include steering control as needed.

FIG. 2 is a conceptual diagram illustrating an example of evacuation control according to the embodiment. An evacuation trajectory TR-E is a target trajectory TR for evacuating the vehicle 1 to a safe target position PTS. The vehicle control system 10 sets the target position PTS based on the recognition result of the recognition sensor 20 and generates the evacuation trajectory TR-E. In the example shown in FIG. 2, the target position PTS is set in a road shoulder in front of the vehicle 1. Then, the vehicle control system 10 executes vehicle traveling control such that the vehicle 1 follows the evacuation trajectory TR-E. In other words, the vehicle control system 10 executes the vehicle traveling control such that the vehicle 1 travels toward the target position PTS and stops at the target position PTS.

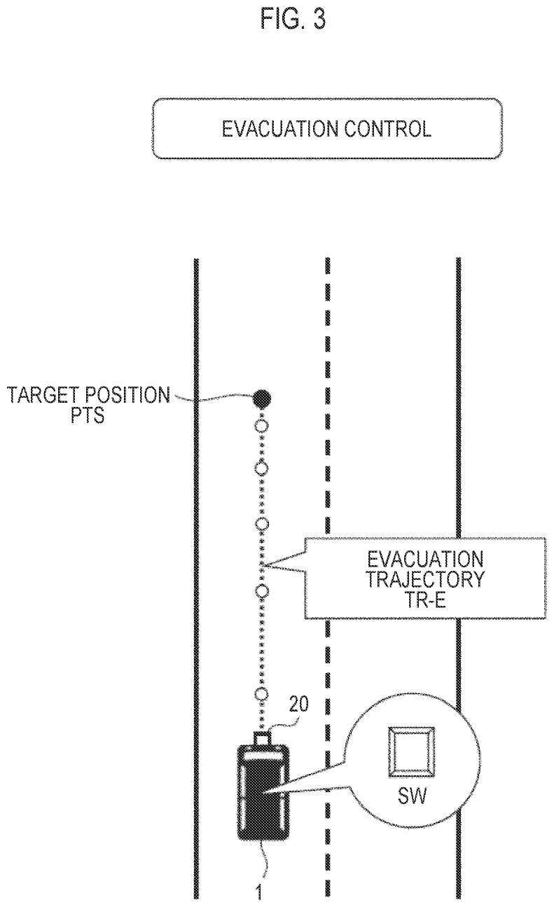

FIG. 3 is a conceptual diagram illustrating another example of evacuation control according to the embodiment. In the example shown in FIG. 3, the target position PTS is set in a lane along which the vehicle 1 is traveling. The vehicle control system 10 generates an evacuation trajectory TR-E and executes the vehicle traveling control such that the vehicle 1 follows the evacuation trajectory TR-E.

As described above, through the evacuation control, it is possible to evacuate the vehicle 1 to the target position PTS. Since the evacuation control is executed in association with the target trajectory TR generated based on the recognition result by the recognition sensor 20, it is possible to stop the vehicle 1 with safety and with high accuracy. That is, it is possible to execute the emergency stop processing with safety and with high accuracy.

Note that, in a situation in which the stop switch SW is pressed, an abnormality may occur in the vehicle traveling control using the recognition sensor 20. For example, the abnormality of the vehicle traveling control results from failure of the recognition sensor 20. As another example, the abnormality of the vehicle traveling control results from an abnormality of a processor that computes the target trajectory TR. When the vehicle traveling control is abnormal, not normal, the accuracy of the above-described evacuation control is not always high. Therefore, according to the embodiment, the following “deceleration-and-stop control” is also prepared for a case where the vehicle traveling control is abnormal when the stop switch SW is pressed.

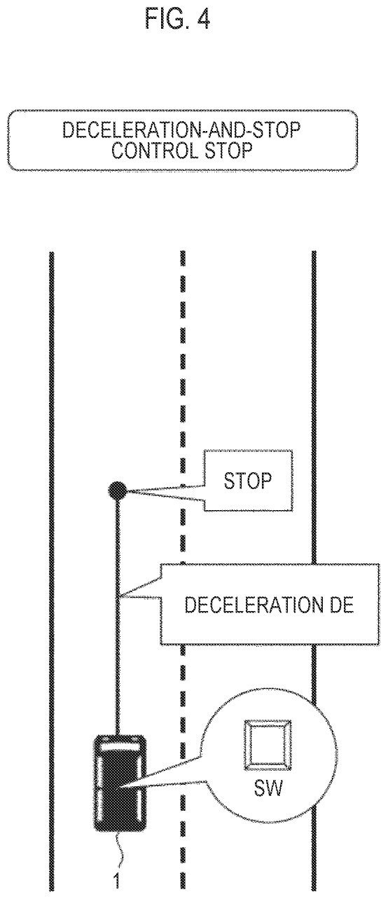

FIG. 4 is a conceptual diagram illustrating deceleration-and-stop control according to the embodiment. In the deceleration-and-stop control, the vehicle control system 10 decelerates the vehicle 1 at a predetermined deceleration DE to stop the vehicle 1. In the deceleration-and-stop control, the recognition sensor 20 is not used, and for this reason, the target trajectory TR is also not generated. That is, the vehicle control system 10 simply decelerates the vehicle 1 at the predetermined deceleration DE to stop the vehicle 1 without using the target trajectory TR. Even with the deceleration-and-stop control, since at least the vehicle 1 is stopped, a minimum extent of safety is secured.

As described above, according to the embodiment, the vehicle control system 10 generates the target trajectory TR based on the recognition result by the recognition sensor 20 and executes the vehicle traveling control for executing control such that the vehicle 1 follows the target trajectory TR. In a case where the vehicle traveling control is normal when the stop switch SW is pressed, the vehicle control system 10 executes the evacuation control that is the vehicle traveling control for evacuating the vehicle 1 to the target position PTS. Since the evacuation control is executed in association with the target trajectory TR generated based on the recognition result by the recognition sensor 20, it is possible to stop the vehicle 1 with safety and with high accuracy.

On the other hand, in a case where the vehicle traveling control is abnormal when the stop switch SW is pressed, the vehicle control system 10 executes the deceleration-and-stop control for decelerating the vehicle 1 to stop the vehicle 1 without using the target trajectory TR. Even with the deceleration-and-stop control, since at least the vehicle 1 is stopped, a minimum extent of safety is secured. Furthermore, since the vehicle traveling control where an abnormality occurs is not used, the occurrence of an unexpected accident is restrained.

In this way, according to the embodiment, it is possible to stop the vehicle 1 with safety depending on situations when the stop switch SW mounted in the vehicle 1 is pressed.

Hereinafter, the vehicle control system 10 according to the embodiment will be described in more detail.

### 2. Vehicle Control System

### 2-1. Configuration Example

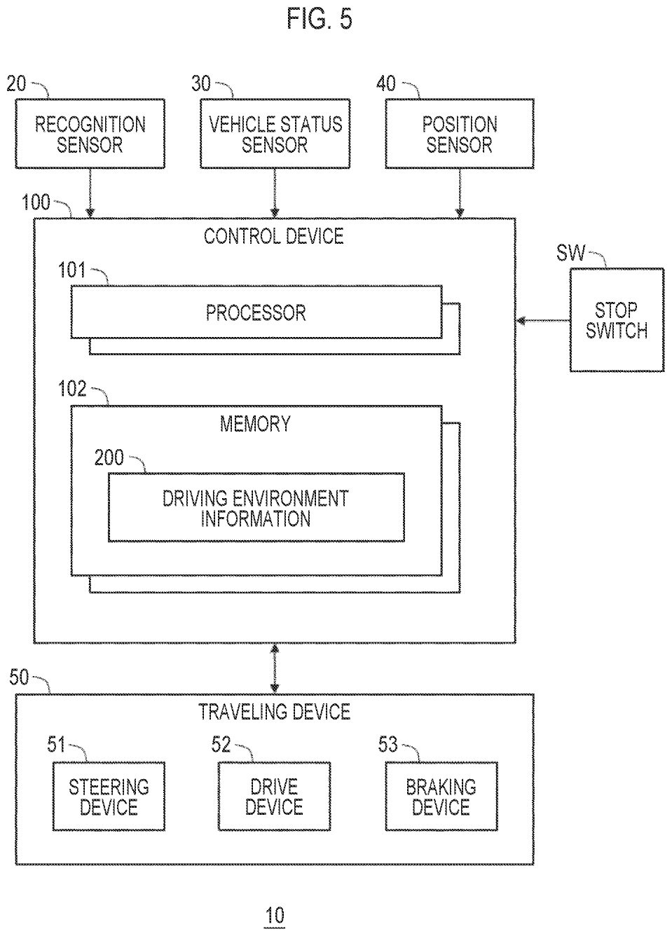

FIG. 5 is a block diagram schematically showing a configuration example of the vehicle control system 10 according to the embodiment. The vehicle control system 10 includes a recognition sensor 20, a vehicle status sensor 30, a position sensor 40, a traveling device 50, a control device 100, and the stop switch SW.

The recognition sensor 20 is mounted in the vehicle 1 and recognizes (detects) a situation around the vehicle 1. Examples of the recognition sensor 20 include LIDAR, a camera, and a radar.

The vehicle status sensor 30 is mounted in the vehicle 1 and detects a status of the vehicle 1. For example, the vehicle status sensor 30 includes a vehicle speed sensor, an acceleration sensor, a yaw rate sensor, and a steering angle sensor.

The position sensor 40 is mounted in the vehicle 1 and detects a position and an azimuth of the vehicle 1. Examples of the position sensor 40 include a global positioning system (GPS) sensor.

The traveling device 50 includes a steering device 51, a drive device 52, and a braking device 53. The steering device 51 turns wheels of the vehicle 1. For example, the steering device 51 includes a power steering (Electric Power Steering (EPS)) device. The drive device 52 is a power source that generates drive power. Examples of the drive device 52 include an engine, an electric motor, and an in-wheel motor. The braking device 53 generates braking force.

The stop switch SW is a switch that is pressed by a person to instruct an emergency stop. The stop switch SW is mounted in the vehicle 1. For example, the stop switch SW is provided in a driver's seat. As another example, when the vehicle 1 is a bus or the like, the stop switch SW may be provided in a passenger space.

The control device 100 controls the vehicle 1. The control device 100 includes one or more processors 101 (hereinafter, simply referred to as a processor 101) and one or more memories 102 (hereinafter, simply referred to as a memory 102). The processor 101 executes various kinds of processing. For example, the processor 101 includes a central processing unit (CPU). The memory 102 stores various kinds of information. Examples of the memory 102 include a volatile memory, a nonvolatile memory, a hard disk drive (HDD), and a solid state drive (SSD). The processor 101 executes a control program that is a computer program, whereby various kinds of processing by the processor 101 (control device 100) are realized. The control program is stored in the memory 102 or is recorded in a computer readable recording medium. The control device 100 may include one or more electronic control units (ECUs). A part of the control device 100 may be an information processing apparatus outside the vehicle 1. In this case, the part of the control device 100 performs communication with the vehicle 1 and controls the vehicle 1 remotely.

### 2-2. Information Acquisition Processing

The processor 101 acquires driving environment information 200 indicating a driving environment of the vehicle 1. The driving environment information 200 is stored in the memory 102.

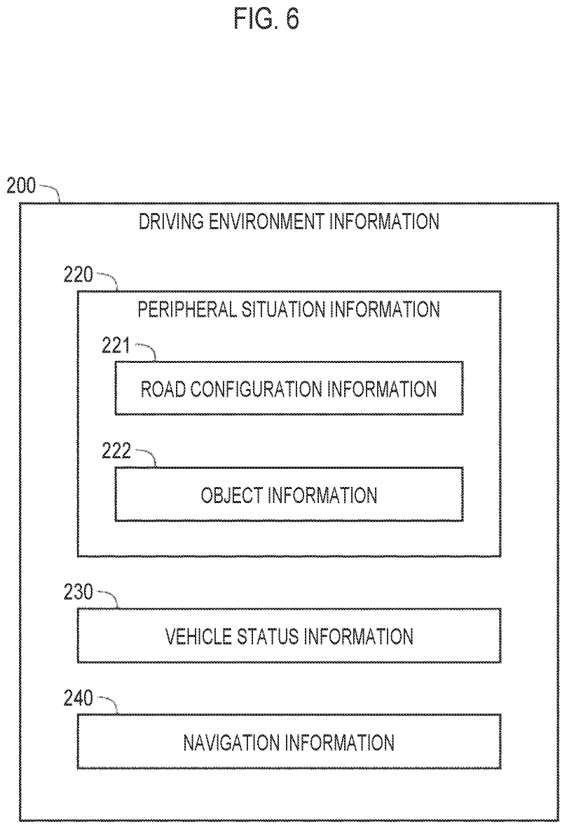

FIG. 6 is a block diagram showing an example of the driving environment information 200. The driving environment information 200 includes peripheral situation information 220, vehicle status information 230, and navigation information 240.

The peripheral situation information 220 is information indicating a situation around the vehicle 1. The peripheral situation information 220 includes information obtained by the recognition sensor 20. For example, the peripheral situation information 220 includes image information captured by a camera. As another example, the peripheral situation information 220 includes point group information obtained by the LIDAR.

The peripheral situation information 220 further includes road configuration information 221 regarding a road configuration around the vehicle 1. The road configuration around the vehicle 1 includes lane markers (white lines) and roadside objects. The roadside object is a stereoscopic obstacle indicating a roadside. Examples of the roadside object include a curbstone, a guardrail, a wall, and a median. The road configuration information 221 indicates at least a position (a relative position with respect to the vehicle 1) of the lane marker or the roadside object. For example, it is possible to identify a road configuration and to calculate a relative position of the road configuration by analyzing the image information obtained by the camera. Examples of an image analysis method include semantic segmentation or edge detection.

The peripheral situation information 220 further includes object information 222 regarding objects around the vehicle 1. Examples of the objects include pedestrians, bicycles, two-wheeled vehicles, other vehicles (preceding vehicles, parked vehicles, and the like), and obstacles. The object information 222 indicates a relative position and a relative speed of an object with respect to the vehicle 1. For example, it is possible to identify an object and to calculate a relative position of the object by analyzing the image information obtained by the camera. It is also possible to identify an object and to acquire a relative position and a relative speed of the object based on the point group information obtained by the LIDAR. The object information may include a movement direction or a movement speed of an object.

The vehicle status information 230 is information indicating a status of the vehicle 1. Examples of the status of the vehicle 1 include a vehicle speed, a yaw rate, a lateral acceleration, and a steering angle. The processor 101 acquires the vehicle status information 230 from a detection result by the vehicle status sensor 30.

The navigation information 240 includes positional information and map information. The positional information indicates a position and an azimuth of the vehicle 1. The positional information is obtained by the position sensor 40. The map information indicates lane disposition, a road shape, and the like. The processor 101 acquires map information of a needed area from a map database. The map database may be stored in a predetermined storage device mounted in the vehicle 1 or may be stored in a management server outside the vehicle 1. In the latter case, the processor 101 performs communication with the management server to acquire needed map information.

### 2-3. Vehicle Traveling Control

The processor 101 executes “vehicle traveling control” for controlling traveling of the vehicle 1. The vehicle traveling control includes steering control, acceleration control, and deceleration control. The processor 101 executes the vehicle traveling control by controlling the traveling device 50. Specifically, the processor 101 executes the steering control by controlling the steering device 51. Furthermore, the processor 101 executes the acceleration control by controlling the drive device 52. In addition, the processor 101 executes the deceleration control by controlling the braking device 53.

An example of the vehicle traveling control is the autonomous driving control for controlling autonomous driving of the vehicle 1. As the autonomous driving herein, it is assumed that a driver may not always concentrate on driving 100% (for example, autonomous driving of so-called level 3 or higher).

Another example of the vehicle traveling control is the traveling assistance control for assisting traveling of the vehicle 1. The traveling assistance control controls at least one of steering, acceleration, and deceleration of the vehicle 1 for improvement of safety of traveling of the vehicle 1. Examples of such traveling assistance control include risk avoidance control and lane departure suppression control. The risk avoidance control executes at least one of steering control and deceleration control to reduce a collision risk of the vehicle 1 with an object. The lane departure suppression control suppress departure of the vehicle 1 from a traveling lane. The traveling assistance control does not constantly operate, and operates in response to establishment of a predetermined operation condition.

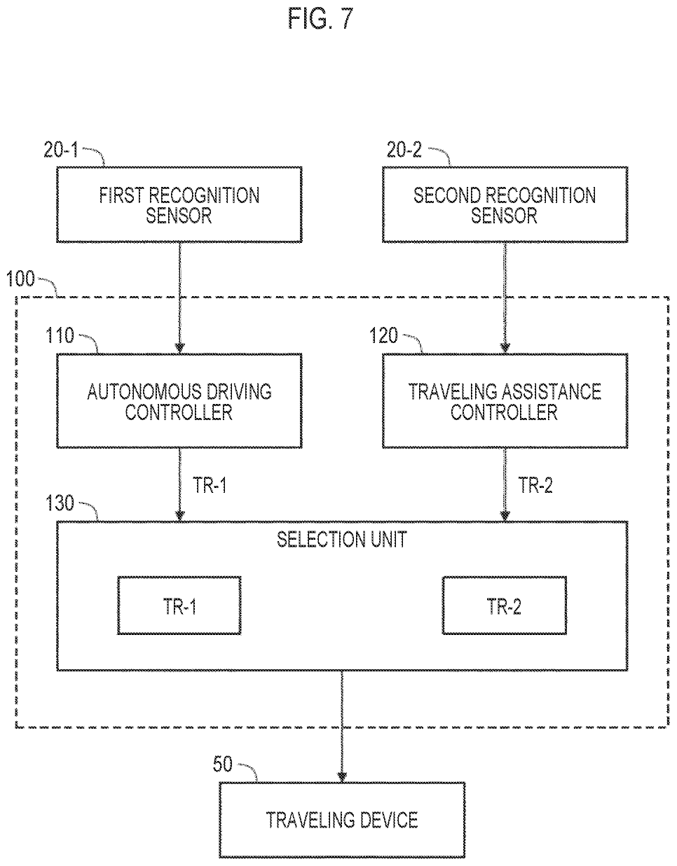

FIG. 7 is a block diagram showing a functional configuration example related to the vehicle traveling control including the autonomous driving control and the traveling assistance control. The recognition sensor 20 includes a first recognition sensor 20-1 and a second recognition sensor 20-2. Examples of the first recognition sensor 20-1 include LIDAR, a camera, and a radar. Examples of the second recognition sensor 20-2 include LIDAR, a camera, and a radar. The first recognition sensor 20-1 and the second recognition sensor 20-2 may be at least partially common.

The control device 100 includes, as functional blocks, an autonomous driving controller 110, a traveling assistance controller 120, and a selection unit 130. The functional blocks are realized by one or more processors 101 executing the control program. The autonomous driving controller 110, the traveling assistance controller 120, and the selection unit 130 may be realized by separated processors 101.

The autonomous driving controller 110 generates an “autonomous driving trajectory TR-1” that is the target trajectory TR for autonomous driving, based on the driving environment information 200. In particular, the autonomous driving controller 110 generates the autonomous driving trajectory TR-1 based on a recognition result by the first recognition sensor 20-1. For example, the autonomous driving controller 110 generates a traveling plan of the vehicle 1 based on the peripheral situation information 220 obtained by the first recognition sensor 20-1 or the navigation information 240. The traveling plan includes keeping a current traveling lane, performing lane change, avoiding an obstacle, and the like. The autonomous driving controller 110 generates autonomous driving trajectory TR-1 needed for the vehicle 1 to travel in association with the traveling plan based on the vehicle status information 230 or the like. The autonomous driving controller 110 generates and updates the autonomous driving trajectory TR-1 in each given cycle. The autonomous driving trajectory TR-1 is output to the selection unit 130.

The traveling assistance controller 120 generates a “traveling assistance trajectory TR-2” that is, the target trajectory TR for the traveling assistance control, based on the driving environment information 200 when an operation condition of the traveling assistance control is established. In particular, the traveling assistance controller 120 generates the traveling assistance trajectory TR-2 based on a recognition result by the second recognition sensor 20-2. The traveling assistance controller 120 generates and updates the traveling assistance trajectory TR-2 in each given cycle. The traveling assistance trajectory TR-2 is output to the selection unit 130.

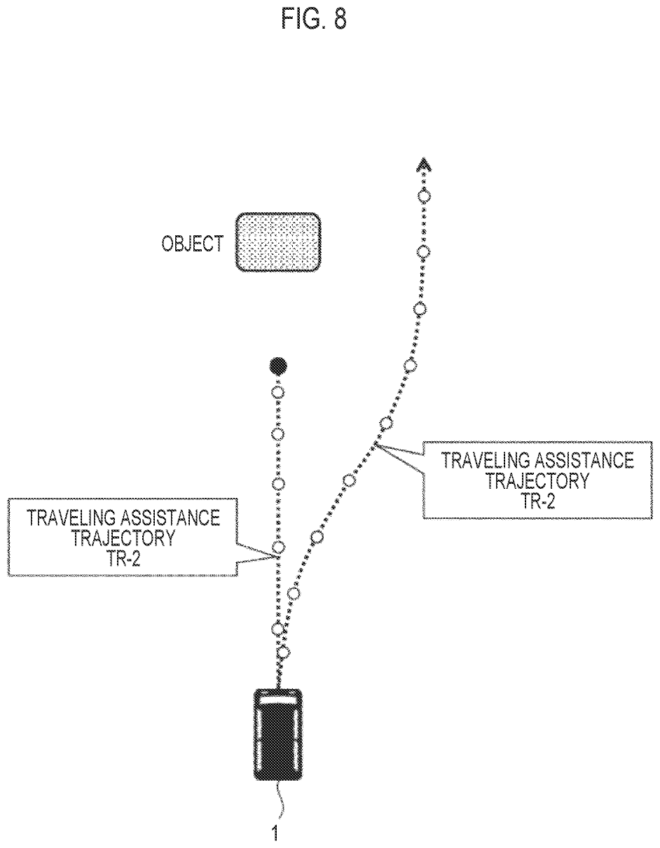

FIG. 8 is a conceptual diagram showing an example of the traveling assistance trajectory TR-2. Here, risk avoidance control for reducing a collision risk of the vehicle 1 with an object is considered. The traveling assistance controller 120 acquires the object information 222 regarding an object (for example, a peripheral vehicle or a pedestrian) in front of the vehicle 1 from the peripheral situation information 220 obtained by the second recognition sensor 20-2. The traveling assistance controller 120 calculates a collision possibility of the vehicle 1 with the object based on the object information 222 or the vehicle status information 230. In a case where the collision possibility is equal to or less than a threshold value, the traveling assistance controller 120 generates the traveling assistance trajectory TR-2 for avoiding collision based on the object information 222 or the vehicle status information 230. The traveling assistance trajectory TR-2 for avoiding collision requests at least one steering and deceleration.

When the operation condition of the traveling assistance control is not established during the execution of the autonomous driving control, the selection unit 130 receives the autonomous driving trajectory TR-1 from the autonomous driving controller 110. The selection unit 130 sets the autonomous driving trajectory TR-1 as the target trajectory TR.

On the other hand, when the operation condition of the traveling assistance control is established during the execution of the autonomous driving control, the selection unit 130 receives the autonomous driving trajectory TR-1 from the autonomous driving controller 110 and receives the traveling assistance trajectory TR-2 from the traveling assistance controller 120. In this case, for example, the selection unit 130 selects any one of the autonomous driving trajectory TR-1 and the traveling assistance trajectory TR-2 as the target trajectory TR. The selection of the autonomous driving trajectory TR-1 and the traveling assistance trajectory TR-2 depends on a design policy. The selection unit 130 may select the autonomous driving trajectory TR-1 with priority or may select the traveling assistance trajectory TR-2 with priority. Alternatively, the selection unit 130 may decide a final target trajectory TR by combining the autonomous driving trajectory TR-1 and the traveling assistance trajectory TR-2.

The processor 101 executes the above-described vehicle traveling control based on the target trajectory TR decided by the selection unit 130. Specifically, the processor 101 executes the vehicle traveling control such that the vehicle 1 follows the target trajectory TR. To this end, the processor 101 calculates a deviation between the vehicle 1 and the target trajectory TR based on the target trajectory TR and the driving environment information 200. Examples of the deviation include a lateral deviation (Y-direction deviation), a yaw angle deviation (azimuth angle deviation), and a speed deviation. Then, the processor 101 executes the vehicle traveling control such that the deviation between the vehicle 1 and the target trajectory TR is decreased. With such vehicle traveling control, the vehicle 1 travels to follow the target trajectory TR.

### 3. Emergency Stop Processing

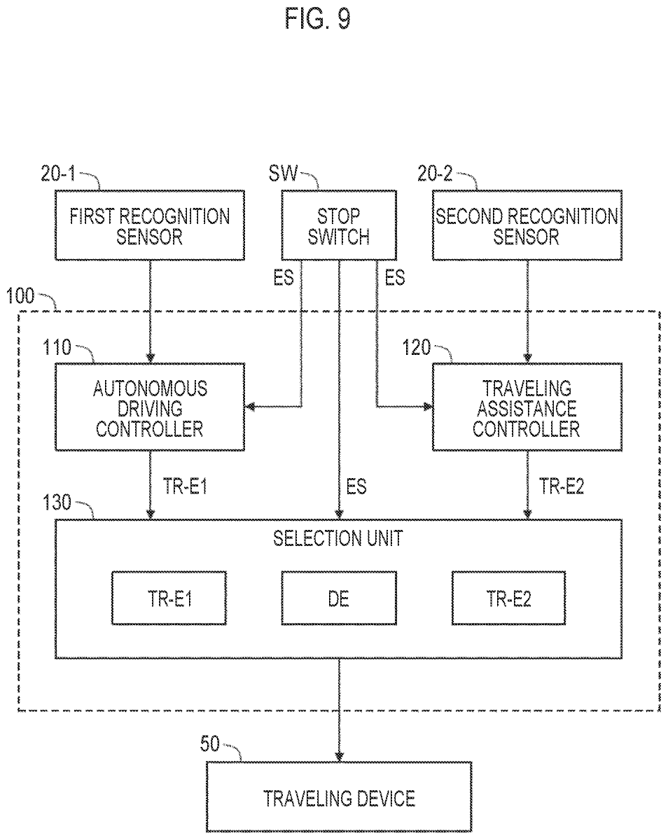

FIG. 9 is a block diagram illustrating the emergency stop processing according to the embodiment. In response to the press of the stop switch SW, the processor 101 executes the emergency stop processing of emergency stopping the vehicle 1. In more detail, when the stop switch SW is pressed, an emergency stop signal ES is output from the stop switch SW. The emergency stop signal ES is supplied to the autonomous driving controller 110, the traveling assistance controller 120, and the selection unit 130.

In a case where the emergency stop signal ES is received, the autonomous driving controller 110 generates the evacuation trajectory TR-E (see FIGS. 2 and 3) for the evacuation control. As described above, the autonomous driving controller 110 generates the autonomous driving trajectory TR-1 based on the recognition result by the first recognition sensor 20-1. The evacuation trajectory TR-E is a kind of the autonomous driving trajectory TR-1. For convenience, the autonomous driving trajectory TR-1 (evacuation trajectory TR-E) for the evacuation control generated by the autonomous driving controller 110 is referred to as a “first evacuation trajectory TR-E1”.

The autonomous driving controller 110 sets the safe target position PTS based on the peripheral situation information 220 obtained by the first recognition sensor 20-1. For example, in the example shown in FIG. 2 described above, the target position PTS is set in the road shoulder. A position of the road shoulder is obtained from the peripheral situation information 220 (road configuration information 221) or the navigation information 240. Then, the autonomous driving controller 110 generates the first evacuation trajectory TR-E1 for evacuating the vehicle 1 to the target position PTS. The first evacuation trajectory TR-E1 is output to the selection unit 130.

In a case where the emergency stop signal ES is received, the traveling assistance controller 120 generates the evacuation trajectory TR-E (see FIGS. 2 and 3) for the evacuation control. The reception of the emergency stop signal ES is one of the operation condition of the traveling assistance control. As described above, the traveling assistance controller 120 generates the traveling assistance trajectory TR-2 based on the recognition result by the second recognition sensor 20-2. The evacuation trajectory TR-E is a kind of the traveling assistance trajectory TR-2. For convenience, the traveling assistance trajectory TR-2 (evacuation trajectory TR-E) for the evacuation control generated by the traveling assistance controller 120 is referred to as a “second evacuation trajectory TR-E2”.

The traveling assistance controller 120 sets the safe target position PTS based on the peripheral situation information 220 obtained by the second recognition sensor 20-2. Then, the traveling assistance controller 120 generates the second evacuation trajectory TR-E2 for evacuating the vehicle 1 to the target position PTS. The second evacuation trajectory TR-E2 is output to the selection unit 130.

In a case where the emergency stop signal ES is received, the selection unit 130 acquires the “predetermined deceleration DE” for the deceleration-and-stop control (see FIG. 4). Information regarding the predetermined deceleration DE is stored in advance in the memory 102.

In this case, when the stop switch SW is pressed, the selection unit 130 acquires the first evacuation trajectory TR-E1, the second evacuation trajectory TR-E2, and the predetermined deceleration DE. The selection unit 130 selects any one of the first evacuation trajectory TR-E1, the second evacuation trajectory TR-E2, and the predetermined deceleration DE. Then, the selection unit 130 executes the emergency stop processing in association with the selected one piece of information.

In determining which of the first evacuation trajectory TR-E1, the second evacuation trajectory TR-E2, and the predetermined deceleration DE is selected, the selection unit 130 takes into consideration whether the vehicle traveling control (autonomous driving control and the traveling assistance control) is normal or abnormal.

For example, the autonomous driving controller 110 has a self-diagnosis function. The self-diagnosis function of the autonomous driving controller 110 determines whether the autonomous driving control is normal or abnormal. Examples of the abnormality of the autonomous driving control include the following.

[Abnormality of Input] Information needed for generating the autonomous driving trajectory TR-1 cannot be appropriately acquired due to failure of the first recognition sensor 20-1.

[Abnormality of Arithmetic Processing] Arithmetic processing of generating the autonomous driving trajectory TR-1 is not operated normally due to an abnormality of the autonomous driving controller 110.

[Abnormality of Arithmetic Result] The generated autonomous driving trajectory TR-1 does not satisfy a predetermined requirement.

[Abnormality of Output] The autonomous driving trajectory TR-1 is not output normally due to failure of an output interface of the autonomous driving controller 110.

For example, the self-diagnosis function of the autonomous driving controller 110 checks the following items. When an abnormality is detected for any item, the self-diagnosis function determines that an abnormality occurs in the autonomous driving control.

[Item 1] Whether or not the processor 101 is operated normally (for example, whether or not an arithmetic cycle of the processor 101 is within a normal range)

[Item 2] Whether or not the first recognition sensor 20-1 is operated normally (for example, whether or not a sensing cycle, the number of pieces of detected data, or a detected data value is within a normal range)

[Item 3] Whether or not the processor 101 receives needed information (for example, whether or not a reception cycle or a data amount is within a normal range)

[Item 4] Whether or not an arithmetic result of the autonomous driving trajectory TR-1 is normal (for example, whether or not a data amount or a data value is within a normal range)

[Item 5] Whether or not the autonomous driving trajectory TR-1 is output normally (for example, whether or not a transmission cycle or a data amount is within a normal range)

The traveling assistance controller 120 also has the same self-diagnosis function. In regard to the self-diagnosis function of the traveling assistance controller 120, the autonomous driving controller 110 is replaced with the traveling assistance controller 120, the first recognition sensor 20-1 is replaced with the second recognition sensor 20-2, and the autonomous driving trajectory TR-1 is replaced with the traveling assistance trajectory TR-2.

The selection unit 130 receives self-diagnosis results from the autonomous driving controller 110 and the traveling assistance controller 120 at regular intervals. The selection unit 130 can know whether the autonomous driving control is normal or abnormal and whether the traveling assistance control is normal or abnormal based on the received self-diagnosis results.

Alternatively, the selection unit 130 may determine whether the autonomous driving control is normal or abnormal based on a reception situation of the autonomous driving trajectory TR-1. For example, when the update of the autonomous driving trajectory TR-1 is stopped for a given period or more, the selection unit 130 determines that an abnormality occurs in the autonomous driving controller 110. As another example, when a value of the autonomous driving trajectory TR-1 received from the autonomous driving controller 110 shows an abnormal value, the selection unit 130 determines that an abnormality occurs in the autonomous driving controller 110. Similarly, the selection unit 130 may determine whether the traveling assistance control is normal or abnormal based on a reception situation of the traveling assistance trajectory TR-2.

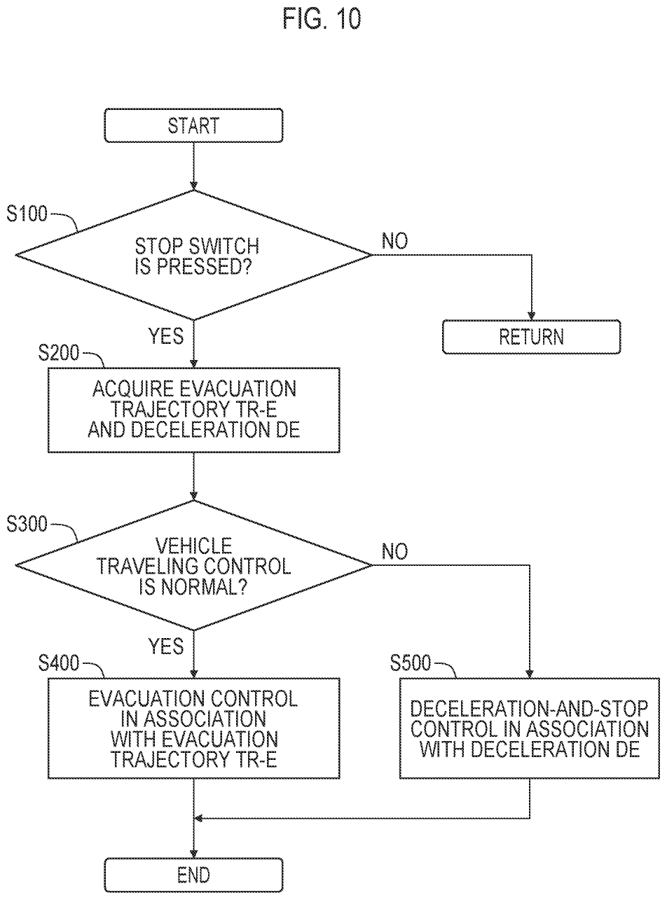

FIG. 10 is a flowchart showing the emergency stop processing according to the embodiment.

In Step S100, the processor 101 determines whether or not the stop switch SW is pressed. When the emergency stop signal ES is received from the stop switch SW, the processor 101 determines that the stop switch SW is pressed (Step S100; Yes). In this case, the process progresses to Step S200. Otherwise (Step S100; No), the process in the present cycle ends.

In Step S200, the processor 101 (autonomous driving controller 110) generates the first evacuation trajectory TR-E1 for the evacuation control. Furthermore, the processor 101 (traveling assistance controller 120) generates the second evacuation trajectory TR-E2 for the evacuation control. In addition, the processor 101 (selection unit 130) acquires the predetermined deceleration DE for the deceleration-and-stop control.

In Step S300, the processor 101 (selection unit 130) determines whether the vehicle traveling control is normal or abnormal. When at least one of the autonomous driving control and the traveling assistance control is normal, the processor 101 determines that the vehicle traveling control is normal (Step S300; Yes). In this case, the process progresses to Step S400. On the other hand, when the vehicle traveling control is not normal, that is, the vehicle traveling control is abnormal (Step S300; No), the process progresses to Step S500.

In Step S400, the processor 101 executes the evacuation control in association with the evacuation trajectory TR-E. That is, the processor 101 executes the evacuation control in association with the first evacuation trajectory TR-E1 or the second evacuation trajectory TR-E2. With this, it is possible to stop the vehicle 1 with safety and with high accuracy.

In Step S500, the processor 101 executes the deceleration-and-stop control in association with the predetermined deceleration DE. With this, a minimum extent of safety is secured. Furthermore, since the vehicle traveling control where an abnormality occurs is not used, the occurrence of an unexpected accident is restrained.

In regards to Steps S300 and S400, various examples are considered. Hereinafter, several examples regarding Steps S300 and S400 will be described.

### 3-1. First Example

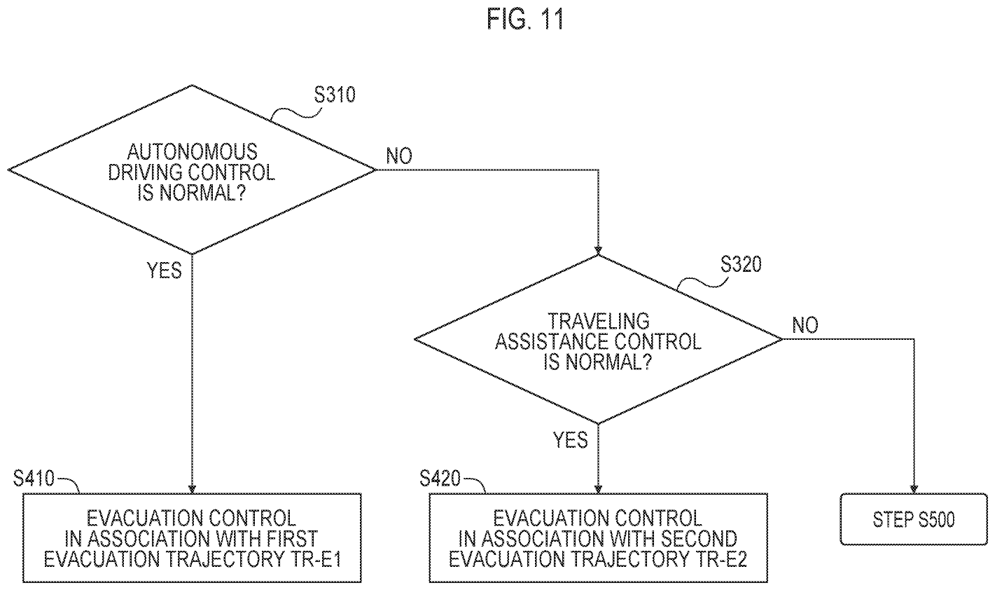

FIG. 11 is a flowchart showing a first example of the emergency stop processing according to the embodiment.

First, in Step S310, the processor 101 (selection unit 130) determines whether the autonomous driving control is normal or abnormal. When the autonomous driving control is normal (Step S310; Yes), the process progresses to Step S410. In Step S410, the processor 101 executes the evacuation control in association with the first evacuation trajectory TR-E1.

On the other hand, when the autonomous driving control is abnormal (Step S310; No), the process progresses to Step S320. In Step S320, the processor 101 (selection unit 130) determines whether the traveling assistance control is normal or abnormal. When the traveling assistance control is normal (Step S320; Yes), the process progresses to Step S420. In Step S420, the processor 101 executes the evacuation control in association with the second evacuation trajectory TR-E2.

When both the autonomous driving control and the traveling assistance control are abnormal (Step S320; No), the process progresses to Step S500 described above.

### 3-2. Second Example

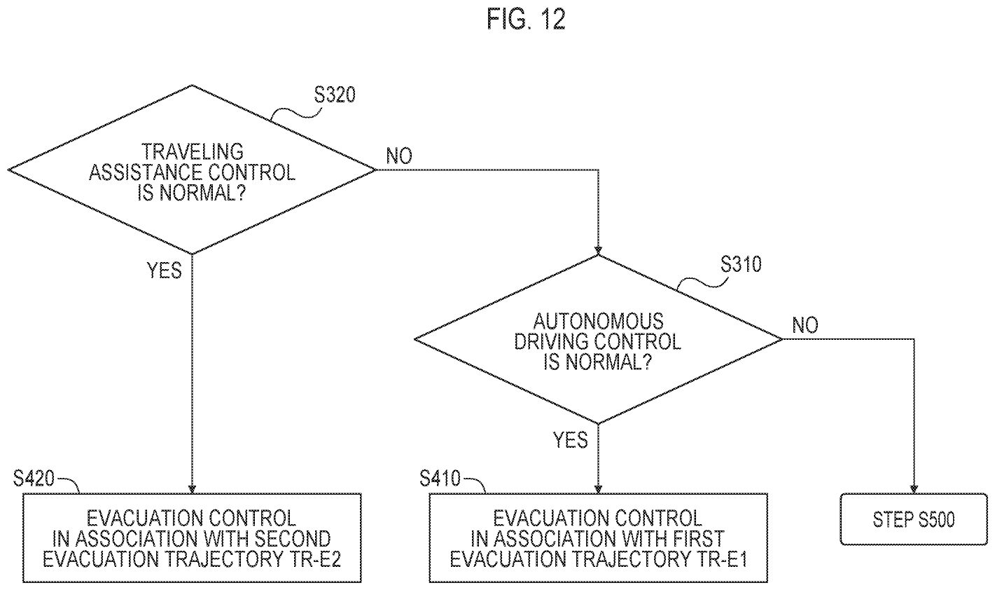

FIG. 12 is a flowchart showing a second example of the emergency stop processing according to the embodiment. In the second example, the order of Steps S310 and S320 is reversed compared to the above-described first example.

First, in Step S320, the processor 101 (selection unit 130) determines whether the traveling assistance control is normal or abnormal. When the traveling assistance control is normal (Step S320; Yes), the process progresses to Step S420. In Step S420, the processor 101 executes the evacuation control in association with the second evacuation trajectory TR-E2.

On the other hand, when the traveling assistance control is abnormal (Step S320; No), the process progresses to Step S310. In Step S310, the processor 101 (selection unit 130) determines whether the autonomous driving control is normal or abnormal. When the autonomous driving control is normal (Step S310; Yes), the process progresses to Step S410. In Step S410, the processor 101 executes the evacuation control in association with the first evacuation trajectory TR-E1.

When both the autonomous driving control and the traveling assistance control are abnormal (Step S310; No), the process progresses to Step S500 described above.

### 3-3. Third Example

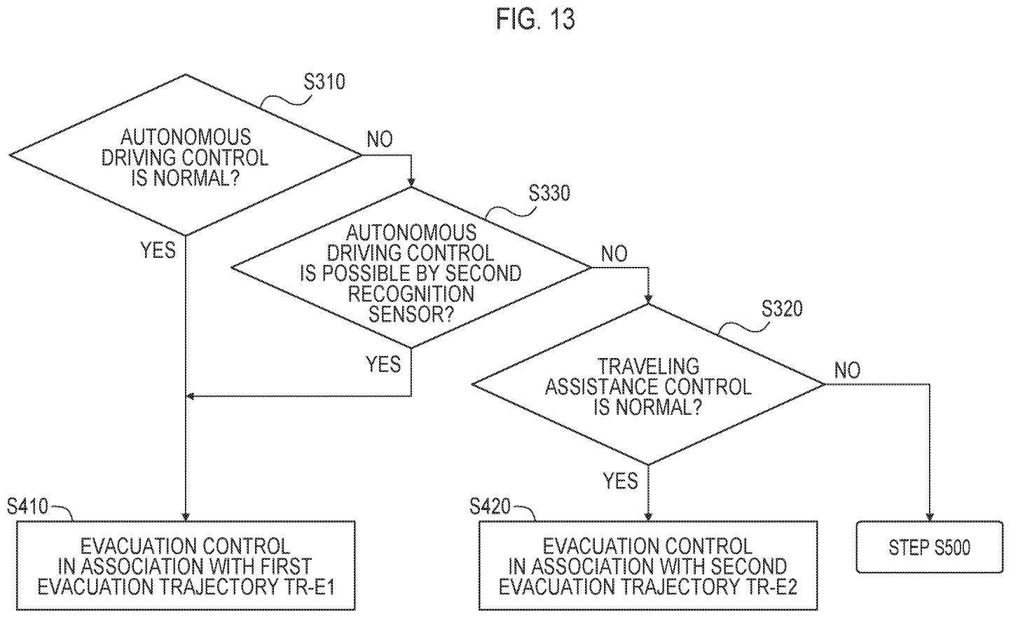

FIG. 13 is a flowchart showing a third example of the emergency stop processing. The third example is a modification example of the first example.

When the autonomous driving control is abnormal (Step S310; No), the process progresses to Step S330.

In Step S330, the processor 101 determines whether or not the autonomous driving control is possible using the second recognition sensor 20-2 instead of the first recognition sensor 20-1. When the abnormality of the autonomous driving control results from failure of the first recognition sensor 20-1, and the second recognition sensor 20-2 is normal, the autonomous driving control is possible using the second recognition sensor 20-2 (Step S330; Yes). In this case, the process progresses to Step S410. In Step S410, the processor 101 (autonomous driving controller 110) generates the first evacuation trajectory TR-E1 for the evacuation control based on the recognition result by the second recognition sensor 20-2 instead of the first recognition sensor 20-1. Then, the processor 101 executes the evacuation control in association with the first evacuation trajectory TR-E1.

On the other hand, when the abnormality of the autonomous driving control results from a factor other than failure of the first recognition sensor 20-1, the autonomous driving control cannot be executed with excellent accuracy even using the second recognition sensor 20-2 instead of the first recognition sensor 20-1 (Step S330; No). In this case, the process progresses to Step S320. Subsequent processing is the same as in a case of the above-described first example.

### 3-4. Fourth Example

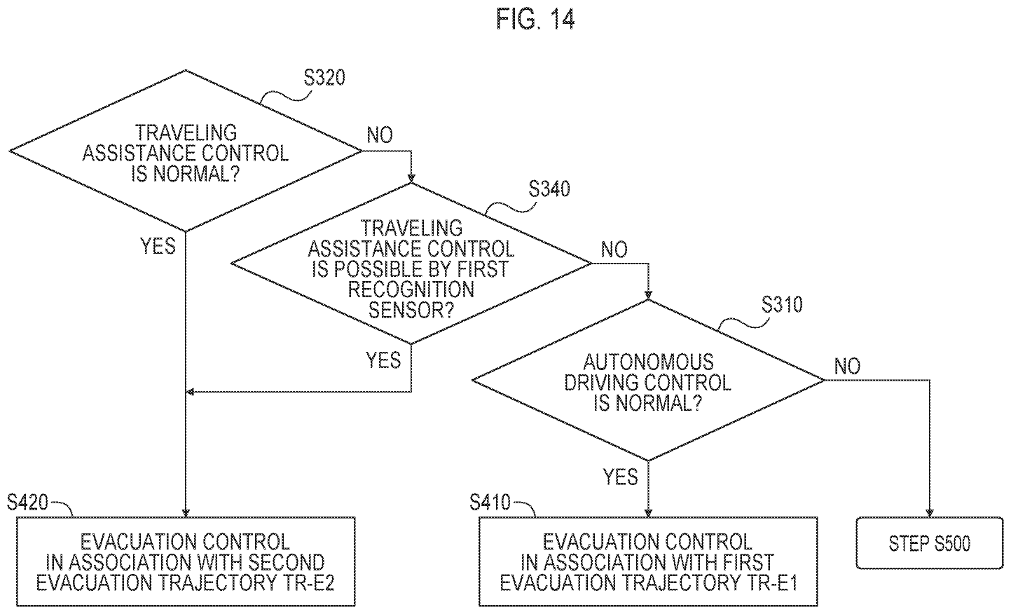

FIG. 14 is a flowchart showing a fourth example of the emergency stop processing. The fourth example is a modification example of the above-described second example.

When the traveling assistance control is abnormal (Step S320; No), the process progresses to Step S340.

In Step S340, the processor 101 determines whether or not the traveling assistance control is possible using the first recognition sensor 20-1 instead of the second recognition sensor 20-2. When the abnormality of the traveling assistance control results from failure of the second recognition sensor 20-2, and the first recognition sensor 20-1 is normal, the traveling assistance control is possible using the first recognition sensor 20-1 (Step S340; Yes). In this case, the process progresses to Step S420. In Step S420, the processor 101 (traveling assistance controller 120) generates the second evacuation trajectory TR-E2 for the evacuation control based on the recognition result by the first recognition sensor 20-1 instead of the second recognition sensor 20-2. Then, the processor 101 executes the evacuation control in association with the second evacuation trajectory TR-E2.

On the other hand, when the abnormality of the traveling assistance control results from a factor other than failure of the second recognition sensor 20-2, the traveling assistance control cannot be executed with excellent accuracy even using the first recognition sensor 20-1 instead of the second recognition sensor 20-2 (Step S340; No). In this case, the process progresses to Step S310. Subsequent processing is the same as in a case of the above-described second example.

What is claimed is:

1. A vehicle control system that controls a vehicle including a stop switch, the vehicle control system comprising:
one or more processors; and
a recognition sensor configured to recognize a situation around the vehicle, wherein
the one or more processors are configured to
execute vehicle traveling control for generating a target trajectory of the vehicle based on a recognition result by the recognition sensor and executing control such that the vehicle follows the target trajectory,
execute evacuation control that is the vehicle traveling control for evacuating the vehicle to a target position in a case where the vehicle traveling control is normal when the stop switch is pressed, and
execute deceleration-and-stop control for decelerating the vehicle to stop the vehicle without using the target trajectory in a case where the vehicle traveling control is abnormal when the stop switch is pressed.

2. The vehicle control system according to claim 1, wherein:
the recognition sensor includes a first recognition sensor and a second recognition sensor;
an autonomous driving trajectory is the target trajectory for autonomous driving of the vehicle;
a traveling assistance trajectory is the target trajectory for improvement of safety of traveling of the vehicle;
the vehicle traveling control includes
autonomous driving control for generating the autonomous driving trajectory based on a recognition result by the first recognition sensor and executing control such that the vehicle follows the autonomous driving trajectory, and
traveling assistance control for generating the traveling assistance trajectory based on a recognition result by the second recognition sensor and executing control such that the vehicle follows the traveling assistance trajectory;
a first evacuation trajectory is the autonomous driving trajectory for evacuating the vehicle;
a second evacuation trajectory is the traveling assistance trajectory for evacuating the vehicle; and
the one or more processors are configured to execute the evacuation control in association with the first evacuation trajectory or the second evacuation trajectory.

3. The vehicle control system according to claim 2, wherein the one or more processors are configured to
execute the evacuation control in association with the first evacuation trajectory in a case where the autonomous driving control is normal when the stop switch is pressed,
execute the evacuation control in association with the second evacuation trajectory in a case where the autonomous driving control is abnormal and the traveling assistance control is normal when the stop switch is pressed, and
execute the deceleration-and-stop control in a case where both the autonomous driving control and the traveling assistance control are abnormal when the stop switch is pressed.

4. The vehicle control system according to claim 2, wherein the one or more processors are configured to
execute the evacuation control in association with the second evacuation trajectory in a case where the traveling assistance control is normal when the stop switch is pressed,
execute the evacuation control in association with the first evacuation trajectory in a case where the traveling assistance control is abnormal and the autonomous driving control is normal when the stop switch is pressed, and
execute the deceleration-and-stop control in a case where both the autonomous driving control and the traveling assistance control are abnormal when the stop switch is pressed.

5. The vehicle control system according to claim 2, wherein the one or more processors are configured to
execute the evacuation control in association with the first evacuation trajectory in a case where the autonomous driving control is normal when the stop switch is pressed,
generate the first evacuation trajectory based on the recognition result by the second recognition sensor instead of the first recognition sensor and execute the evacuation control in association with the first evacuation trajectory in a case where the autonomous driving control is abnormal when the stop switch is pressed, the abnormality of the autonomous driving control results from failure of the first recognition sensor, and the second recognition sensor is normal,
execute the evacuation control in association with the second evacuation trajectory in a case where the abnormality of the autonomous driving control results from a factor other than the failure of the first recognition sensor and the traveling assistance control is normal, and
execute the deceleration-and-stop control in a case where both the autonomous driving control and the traveling assistance control are abnormal when the stop switch is pressed.

6. The vehicle control system according to claim 2, wherein the one or more processors are configured to
execute the evacuation control in association with the second evacuation trajectory in a case where the traveling assistance control is normal when the stop switch is pressed,
generate the second evacuation trajectory based on the recognition result by the first recognition sensor instead of the second recognition sensor and execute the evacuation control in association with the second evacuation trajectory in a case where the traveling assistance control is abnormal when the stop switch is pressed, the abnormality of the traveling assistance control results from failure of the second recognition sensor, and the first recognition sensor is normal,
execute the evacuation control in association with the first evacuation trajectory in a case where the abnormality of the traveling assistance control results from a factor other than the failure of the second recognition sensor and the autonomous driving control is normal, and
execute the deceleration-and-stop control in a case where both the autonomous driving control and the traveling assistance control are abnormal when the stop switch is pressed.

7. The vehicle control system according to claim 1, wherein the one or more processors are configured to determine that the vehicle traveling control is abnormal in a case where the recognition sensor fails or in a case where an abnormality occurs in at least one of an arithmetic operation and an output of the target trajectory.
